(19) United States
(12) Patent Application Publication
(10) Pub. No.: US 2021/0069988 A1
(43) Pub. Date: Mar. 11, 2021

(54) THREE-DIMENSIONAL ADDITIVE MANUFACTURING APPARATUS, THREE-DIMENSIONAL ADDITIVE MANUFACTURING APPARATUS ADJUSTMENT METHOD, AND THREE-DIMENSIONAL ADDITIVE MANUFACTURING APPARATUS ADJUSTMENT PROGRAM

(71) Applicant: KANTATSU CO., LTD., Tokyo (JP)

(72) Inventors: Eiji OSHIMA, Tokyo (JP); Shunsuke NIREI, Tokyo (JP)

(21) Appl. No.: 16/932,461

(22) Filed: Jul. 17, 2020

(30) Foreign Application Priority Data
Jul. 17, 2019 (JP) 2019-134105

(51) Int. Cl. B29C 64/393; B29C 64/124; B29C 64/245; B29C 64/255; B33Y 10/00; B33Y 30/00; B33Y 50/02

(52) U.S. Cl. CPC B29C 64/393; B29C 64/124; B29C 64/245; B33Y 50/02; B33Y 10/00; B33Y 30/00; B29C 64/255

(57) ABSTRACT

The present invention allows precise positioning of a vat and a platform.

A three-dimensional additive manufacturing apparatus includes: a vat being a member to contain a manufacturing material and having a bottom surface to transmit a light beam from a light source provided below; a platform having a downward manufacturing surface facing the bottom surface and configured to lift a manufactured object for each manufacture of one layer, the manufactured object being additively manufactured per layer on the manufacturing surface; a biasing member biasing upward the vat while supporting; and an adjustment member configured to adjust a vertical position of the vat at least at three points, wherein in a state where the platform is moved downward to contact the manufacturing surface with the bottom surface and press down the vat against a biasing force of the biasing member, the position of the vat is adjusted using the adjustment member.

### BACKGROUND OF THE INVENTION

### 1. Field of the Invention

The present invention relates to a three-dimensional additive manufacturing apparatus, a three-dimensional additive manufacturing apparatus adjustment method, and a three-dimensional additive manufacturing apparatus adjustment program.

### 2. Description of the Related Art

In the above technical field, JP 2017-124631 A discloses a three-dimensional manufacturing apparatus including a table, a vessel, a holder, and an optical device, wherein the vessel containing a photocurable liquid resin is mounted on the table and the cured photocurable resin is lifted with a holder.

The technique described in JP 2017-124631 A is, however, not capable of adjusting a position of the vessel (vat) relative to the holder (platform) because the vessel (vat) is fixed on the table.

### SUMMARY

It is an object of the present invention to provide a technique to solve the above problem.

To achieve the above object, a three-dimensional additive manufacturing apparatus according to the present invention includes:

a vat being a member to contain a manufacturing material and having a bottom surface to transmit a light beam from a light source provided below;

a platform having a downward manufacturing surface facing the bottom surface and configured to lift a manufactured object for each manufacture of one layer, the manufactured object being additively manufactured per layer on the manufacturing surface;

a biasing member biasing upward the vat while supporting; and

an adjustment member configured to adjust a vertical position of the vat at least at three points, wherein

in a state where the platform is moved downward to contact the manufacturing surface with the bottom surface and press down the vat against a biasing force of the biasing member, the position of the vat is adjusted using the adjustment member.

To achieve the above object, a three-dimensional additive manufacturing apparatus adjustment method according to the present invention is a method of adjusting a three-dimensional additive manufacturing apparatus including

a vat being a member to contain a manufacturing material and having a bottom surface to transmit a light beam from a light source provided below,

a platform having a downward manufacturing surface facing the bottom surface and configured to lift a manufactured object for one layer, the manufactured object being additively manufactured per layer on the manufacturing surface,

an upward biasing member biasing upward the vat while supporting, and

an adjustment member configured to adjust a vertical position of the vat at least at three points, the method including the steps of:

moving the platform downward;

contacting the manufacturing surface with the bottom surface and pressing down the vat against a biasing force of the biasing member; and

fixing a position of the vat using the adjustment member in a state where the vat is pressed down.

To achieve the above object, a three-dimensional additive manufacturing apparatus adjustment program according to the present invention is a program for adjusting a three-dimensional additive manufacturing apparatus including

a vat being a member to contain a manufacturing material and having a bottom surface to transmit a light beam from a light source provided below,

a platform having a downward manufacturing surface facing the bottom surface and configured to lift a manufactured object for one layer, the manufactured object being additively manufactured per layer on the manufacturing surface,

an upward biasing member biasing upward the vat while supporting, and

an adjustment member configured to adjust a vertical position of the vat at least at three points, the program causing a computer to execute the steps of:

moving the platform downward;

contacting the manufacturing surface with the bottom surface and pressing down the vat against a biasing force of the biasing member; and

fixing a position of the vat using the adjustment member in a state where the vat is pressed down.

The present invention allows adjustment of a position of the vat relative to the platform.

### BRIEF DESCRIPTION OF THE DRAWINGS

FIG. 1A is a perspective view illustrating a three-dimensional manufacturing apparatus according to a first embodiment of the present invention.

FIG. 1B is a side view illustrating the three-dimensional manufacturing apparatus according to the first embodiment of the present invention.

FIG. 1C is a front view illustrating the three-dimensional manufacturing apparatus according to the first embodiment of the present invention.

FIG. 2A is a perspective view illustrating a three-dimensional additive manufacturing apparatus according to a second embodiment of the present invention.

FIG. 2B is a side view illustrating the three-dimensional additive manufacturing apparatus according to the second embodiment of the present invention.

FIG. 2C is a front view illustrating the three-dimensional additive manufacturing apparatus according to the second embodiment of the present invention.

FIG. 3A is a front view illustrating a vat guide of the three-dimensional additive manufacturing apparatus according to the second embodiment of the present invention.

FIG. 3B is a perspective view illustrating the vat guide of the three-dimensional additive manufacturing apparatus according to the second embodiment of the present invention.

FIG. 3C is a front cross-sectional schematic view illustrating the vat guide of the three-dimensional additive manufacturing apparatus according to the second embodiment of the present invention.

FIG. 4A is a perspective view illustrating a procedure of positioning of a platform by the three-dimensional additive manufacturing apparatus according to the second embodiment of the present invention.

FIG. 4B is a perspective view illustrating the procedure of positioning of the platform by the three-dimensional additive manufacturing apparatus according to the second embodiment of the present invention.

FIG. 4C is a perspective view illustrating the procedure of positioning of the platform by the three-dimensional additive manufacturing apparatus according to the second embodiment of the present invention.

FIG. 4D is a perspective view illustrating the procedure of positioning of the platform by the three-dimensional additive manufacturing apparatus according to the second embodiment of the present invention.

FIG. 4E is a perspective view illustrating the procedure of positioning of the platform by the three-dimensional additive manufacturing apparatus according to the second embodiment of the present invention.

FIG. 4F shows a perspective view and a cross-sectional schematic view illustrating the procedure of positioning of the platform by the three-dimensional additive manufacturing apparatus according to the second embodiment of the present invention.

FIG. 4G is a perspective view illustrating the procedure of positioning of the platform by the three-dimensional additive manufacturing apparatus according to the second embodiment of the present invention.

FIG. 4H shows a perspective view and a cross-sectional schematic view illustrating the procedure of positioning of the platform by the three-dimensional additive manufacturing apparatus according to the second embodiment of the present invention.

FIG. 4I is a perspective view illustrating the procedure of positioning of the platform by the three-dimensional additive manufacturing apparatus according to the second embodiment of the present invention.

FIG. 5 is a diagram illustrating a block used for the three-dimensional additive manufacturing apparatus according to the second embodiment of the present invention.

FIG. 6 is a chart illustrating an example of an adjustment table of an information processing section included in the three-dimensional additive manufacturing apparatus according to the second embodiment of the present invention.

FIG. 7 is a block diagram illustrating hardware configuration of the information processing section included in the three-dimensional additive manufacturing apparatus according to the second embodiment of the present invention.

FIG. 8 is a flowchart illustrating a processing procedure by the information processing section included in the three-dimensional additive manufacturing apparatus according to the second embodiment of the present invention.

FIG. 9 is a perspective view illustrating a three-dimensional additive manufacturing apparatus according to a third embodiment of the present invention.

FIG. 10 is a perspective view illustrating a three-dimensional additive manufacturing apparatus according to a fourth embodiment of the present invention.

### DETAILED DESCRIPTION OF THE PREFERRED EMBODIMENTS

Embodiments of the present invention are exemplarily described below in detail with reference to the drawings. It should be noted that the configuration, the numerical values, the process flows, the functional components, and the like described in the embodiments below are merely examples and may be freely modified or altered. The technical scope of the present invention is not intended to be limited to the following description.

### First Embodiment

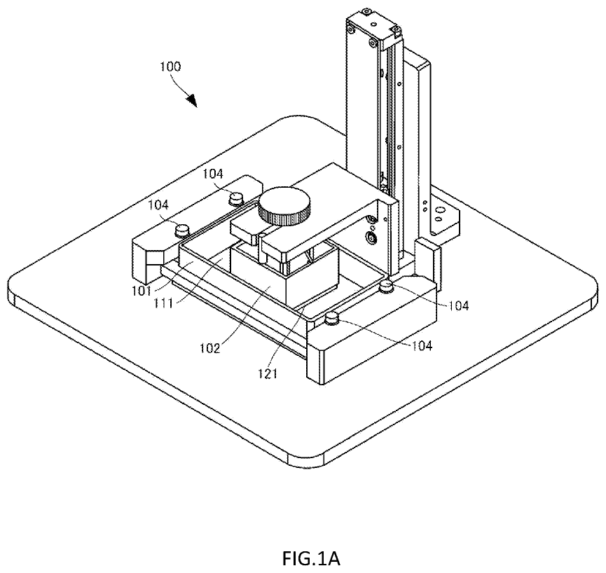

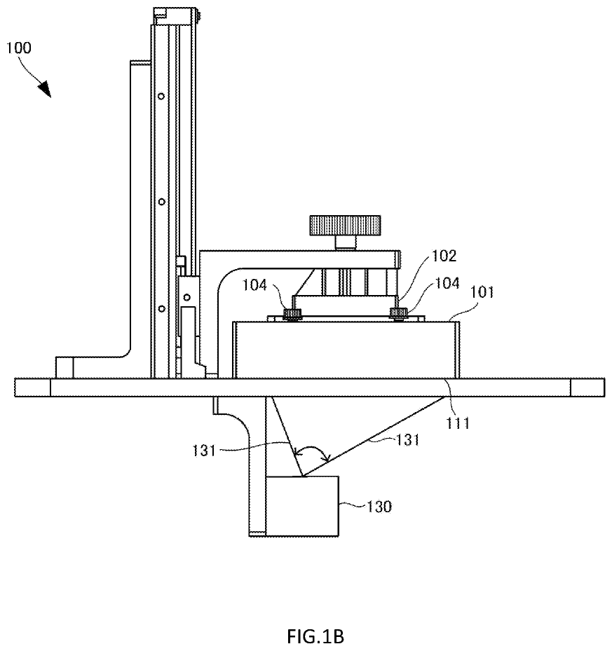

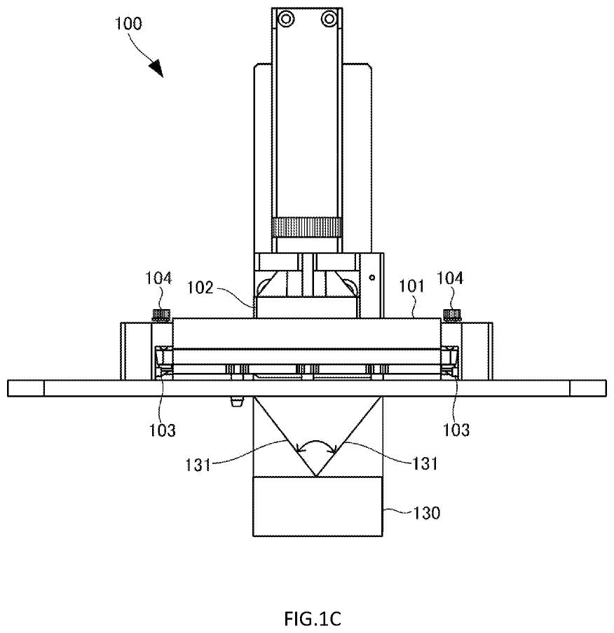

With reference to FIG. 1A through 1C, a three-dimensional additive manufacturing apparatus 100 is described as the first embodiment of the present invention. FIG. 1A is a perspective view illustrating the three-dimensional manufacturing apparatus according to the present embodiment. FIG. 1B is a side view illustrating the three-dimensional manufacturing apparatus according to the present embodiment. FIG. 1C is a front view illustrating the three-dimensional manufacturing apparatus according to the present embodiment.

As illustrated in FIGS. 1A through 1C, the three-dimensional additive manufacturing apparatus 100 includes a vat 101, a platform 102, biasing members 103, and adjustment members 104. The vat 101 is a member to contain a manufacturing material and has a bottom surface 111 to transmit a light beam 131 from a light source 130 provided below. The platform 102 has a downward manufacturing surface 121 facing the bottom surface 111 and is configured to lift a manufactured object for each manufacture of one layer, the manufactured object being additively manufactured per layer on the manufacturing surface 121. The biasing members 103 bias upward the vat 101 while supporting. The adjustment members 104 are configured to adjust a vertical position of the vat 101 at least at three points. In a state where the platform 102 is moved downward to contact the manufacturing surface 121 with the bottom surface 111 and the vat 101 is pressed down against biasing forces of the biasing members 103, the three-dimensional additive manufacturing apparatus 100 is configured to adjust a position of the vat 101 using the adjustment members 104.

The present embodiment allows vertical positioning of the vat with the biasing members and the adjustment members, thereby allowing adjustment of the position of the vat relative to the platform.

### Second Embodiment

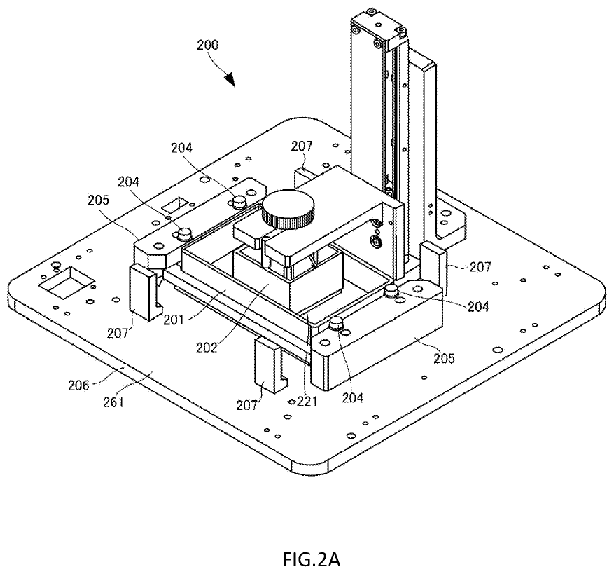

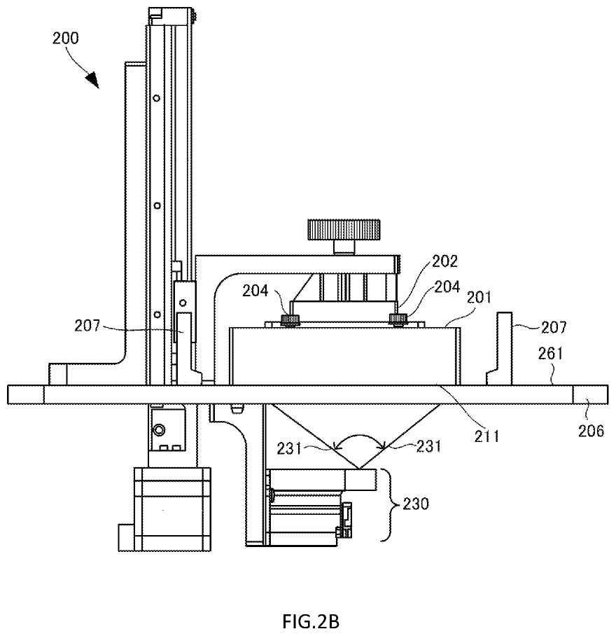

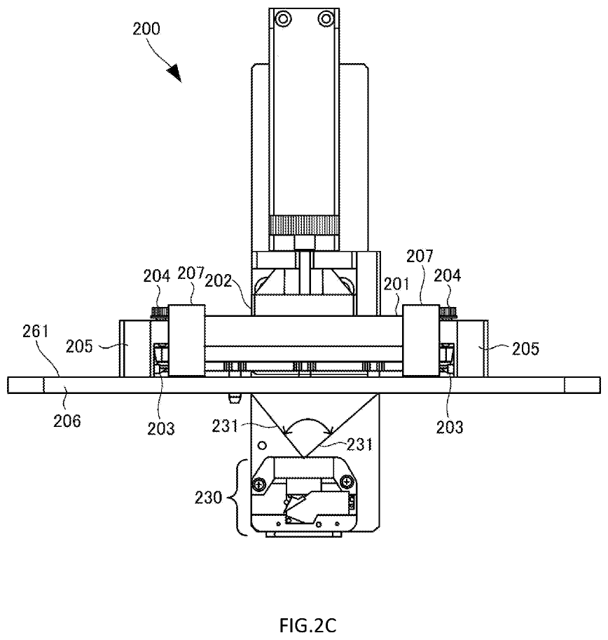

With reference to FIGS. 2A through 8, a three-dimensional additive manufacturing apparatus according to the second embodiment of the present invention is then described. FIG. 2A is a perspective view illustrating a three-dimensional additive manufacturing apparatus according to a second embodiment. FIG. 2B is a side view illustrating the three-dimensional additive manufacturing apparatus according to the second embodiment. FIG. 2C is a front view illustrating the three-dimensional additive manufacturing apparatus according to the second embodiment.

A three-dimensional additive manufacturing apparatus 200 includes a vat 201, a platform 202, biasing members 203, adjustment members 204, vat guides 205, and a manufacturing base 206.

The vat 201 is a member to contain a manufacturing material and has a bottom surface 211 to transmit a light beam 231 from a light source 230 provided below the vat 201. The bottom surface 211 of the vat 201 transmits the light beam 231 from the light source 230. With the light beam 231 transmitted through the bottom surface 211 of the vat 201, the manufacturing material, such as a photocurable resin, contained in the vat 201 is irradiated to be cured. The light beam 231 used for irradiation of the manufacturing material has a wavelength of 405 nm.

The platform 202 has a downward manufacturing surface 221 facing the bottom surface 211 of the vat 201. A three-dimensional additively manufactured object is manufactured on the manufacturing surface 221. In a state where the manufacturing surface 221 is moved down to a manufacture starting position in the vat 201, the platform 202 is irradiated with the light beam 231 from the light source 230. When irradiation with the light beam 231 for one layer is completed to manufacture one layer of the manufactured object, the platform 202 is lifted for the thickness of one layer of the manufactured object. After completion of the lifting, irradiation with the light beam 231 is started to manufacture the next layer. The three-dimensional additive manufacturing apparatus 200 repeats such operation to manufacture a three-dimensional additively manufactured object. The thickness for one layer of the three-dimensional additively manufactured object, that is, a pitch to raise the platform 202 is, but not limited to, 2.5 μm. The pitch may be appropriately set in accordance with the manufacturing material and the three-dimensional additively manufactured object to be manufactured.

The biasing members 203 bias upward the vat 201 while supporting. Examples of the biasing members 203 are, but not limited to, leaf springs, coil springs, and the like. The adjustment members 204 press the vat 201 down against biasing forces of the biasing members 203. The vat 201 is fixed in a predetermined position while being sandwiched between the biasing members 203 and the adjustment members 204. The vat 201 and the platform 202 are then positioned in a state where the platform 202 is moved downward and to contact the manufacturing surface 221 of the platform 202 with an upper surface side of the bottom surface 211.

That is, while the manufacturing surface 221 contacts the bottom surface 211, the vat 201 is biased upward by the biasing members 203 and also pressed down against the biasing forces of the biasing members 203. The vat 201 is positioned in this state by the adjustment members 204. The adjustment members 204 are, for example, screws and the screws are fastened to hold the vat 201 from above, thereby allowing positioning of the vat 201.

The vat guides 205 guide the vat 201 to be arranged in a predetermined position. The vat guides 205 are attached to a reference plane 261, which is an upper surface of the manufacturing base 206. Attachment of the vat guides 205 to the reference plane 261 defines the positions of the adjustment members 204 from the reference plane 261. In other words, the adjustment members 204 are attached to screw holes provided in the vat guides 205, and thus determination of the positions of the vat guides 205 determines positions of the adjustment members 204 relative to the reference plane 261.

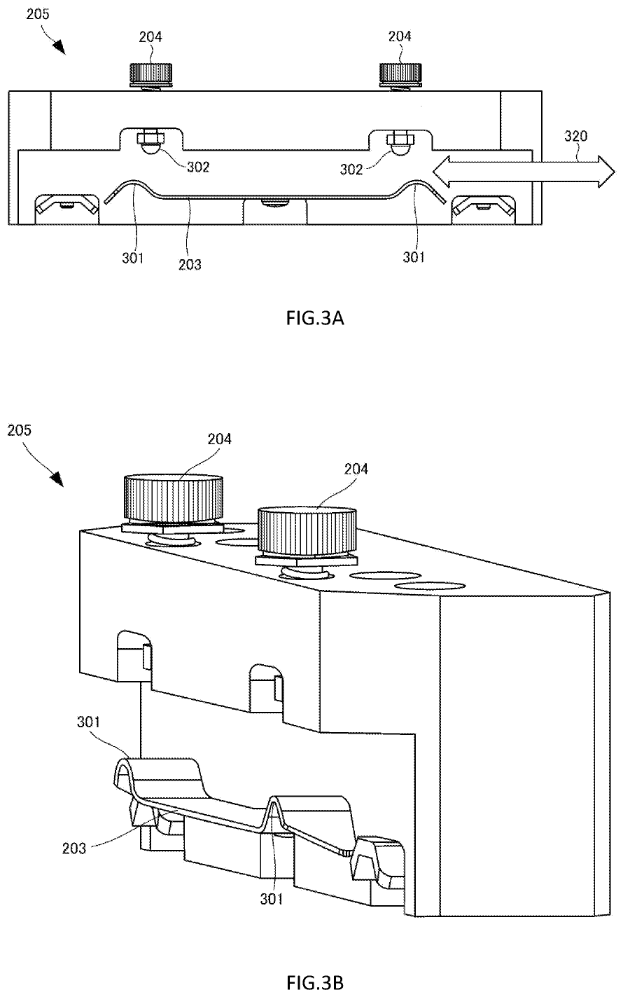

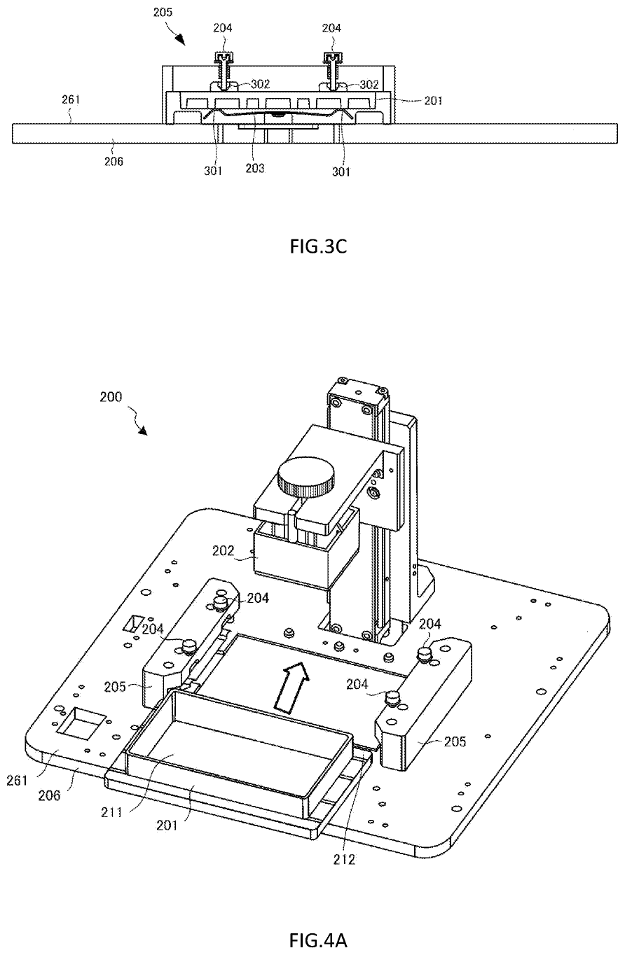

FIG. 3A is a front view illustrating the vat guide of the three-dimensional additive manufacturing apparatus according to the second embodiment. FIG. 3B is a perspective view illustrating the vat guide of the three-dimensional additive manufacturing apparatus according to the second embodiment. FIG. 3C is a front cross-sectional schematic view illustrating the vat guide of the three-dimensional additive manufacturing apparatus according to the second embodiment. The vat guides 205 include the biasing members 203 and the adjustment members 204. The vat guides 205 guide an end edge portion 212 of the vat 201 between the biasing members 203 and the adjustment members 204. The vat 201 is guided in the directions of an arrow 320 to be attached to and detached from the vat guides 205.

The adjustment members 204 are attached to the screw holes provided in the vat guides 205. The vat guides 205 are then mounted on the manufacturing base 206 to define the positions of the adjustment members 204 from the reference plane 261 of the manufacturing base 206.

The biasing members 203 are provided in positions below the vat guides 205, that is, on a side closer to the manufacturing base 206. Each biasing member 203 has both ends provided with respective upwardly convex pressing portions 301. The pressing portions 301 at both ends of the biasing member 203 bias the end edge portion 212 of the vat 201 upward from below and support the end edge portion 212.

Examples of the biasing members 203 are, but not limited to, leaf springs, coil springs, and the like.

The end edge portion 212 of the vat 201 contacts the adjustment members 204 at screw ends 302 of the adjustment members 204. The adjustment members 204 (screw ends 302) press down the vat 201 inserted into the vat guides 205 downward from above against the biasing force of the biasing member 203. The vat 201 inserted into the vat guides 205 is sandwiched between the respective pressing portions 301 and the screw ends 302 to be fixed to the vat guides 205.

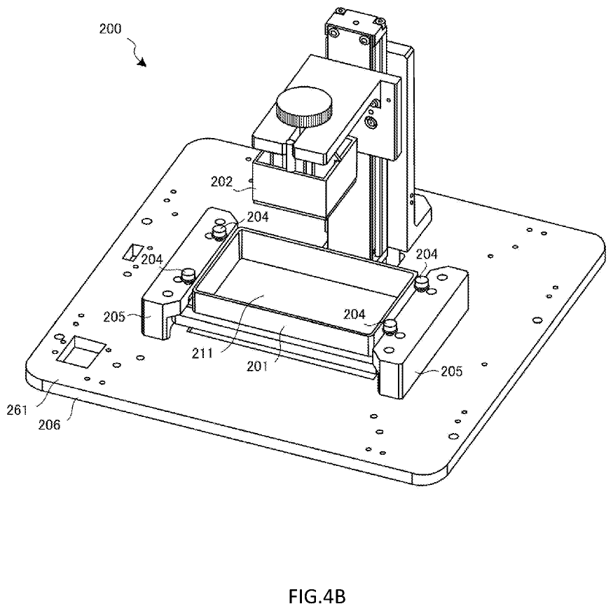

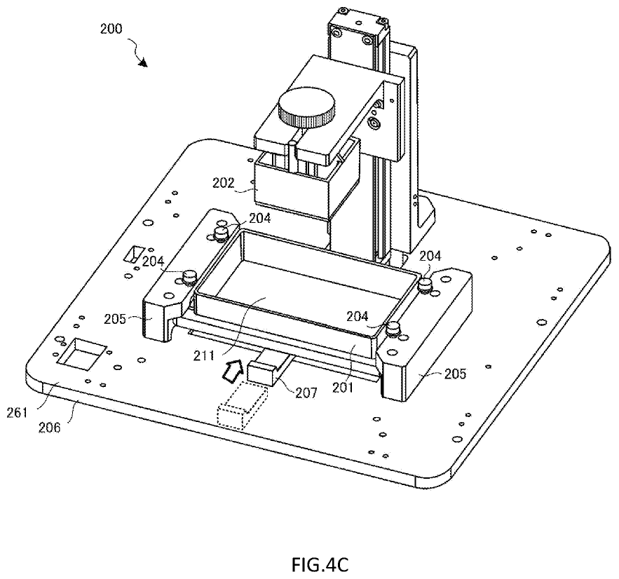

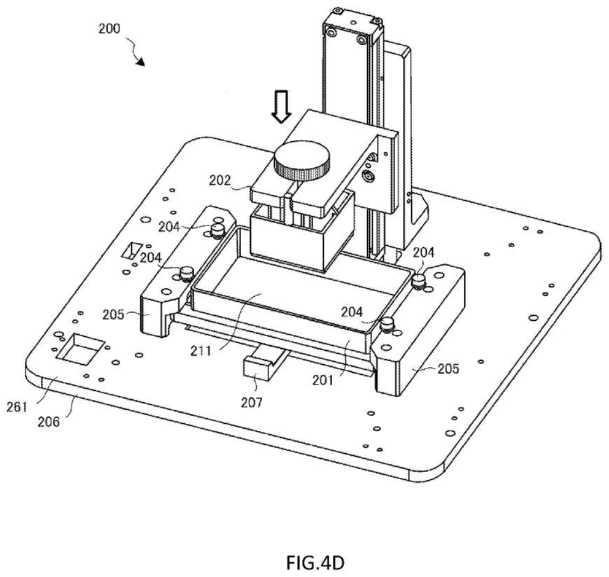

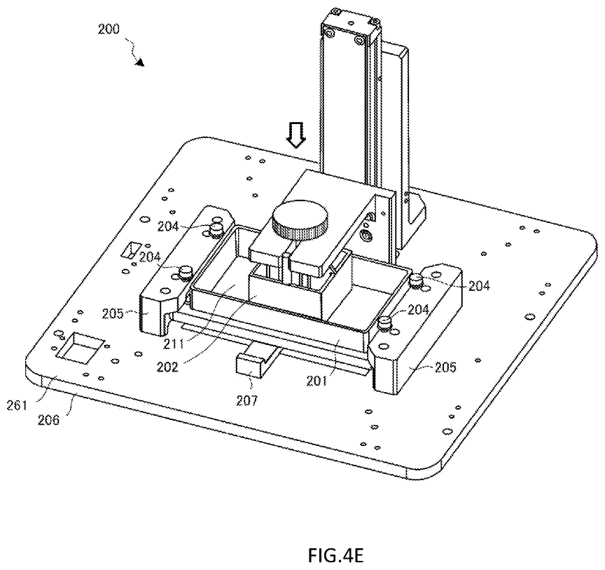

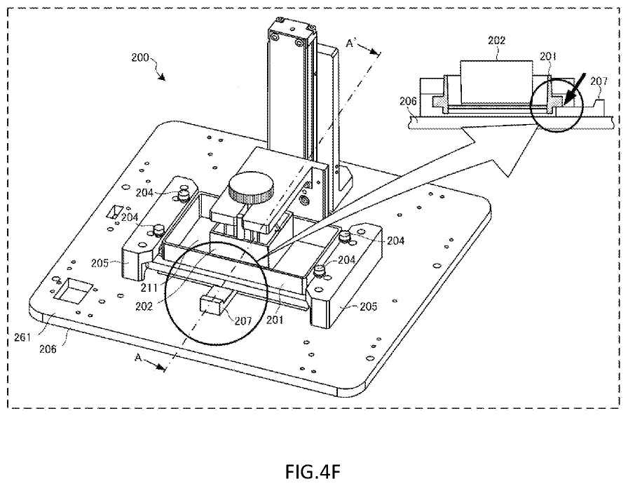

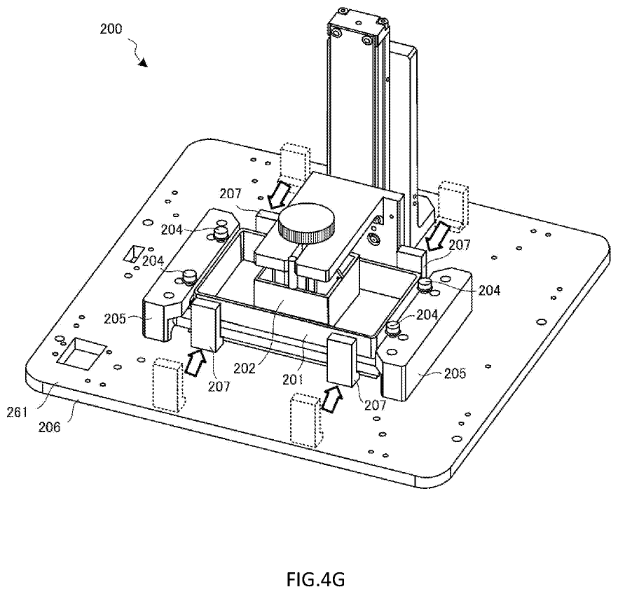

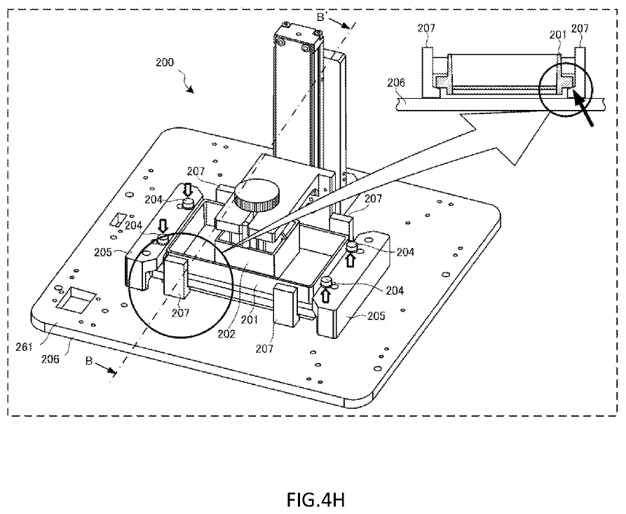

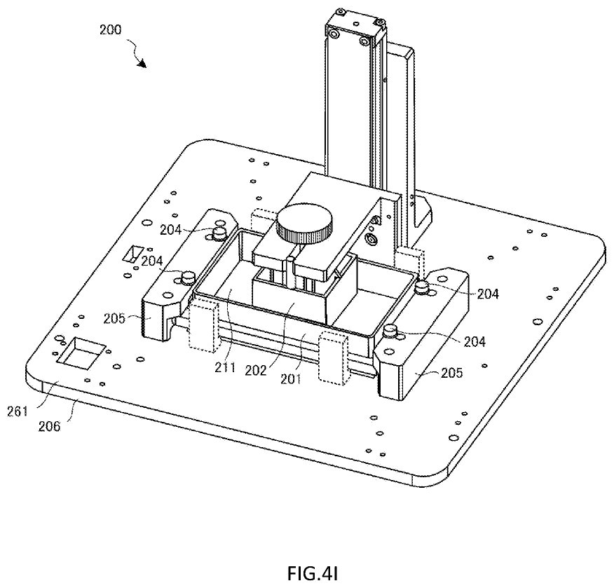

With reference to FIGS. 4A through 4I, a procedure of positioning of the platform 202 by the three-dimensional additive manufacturing apparatus 200 is then described. FIG. 4A is a perspective view illustrating the procedure of positioning by the three-dimensional additive manufacturing apparatus according to the present embodiment. First, the platform 202 is attached to the three-dimensional additive manufacturing apparatus 200 and the vat 201 is inserted into the vat guides 205 as indicated by the arrow.

FIG. 4B is a perspective view illustrating the procedure of positioning of the platform by the three-dimensional additive manufacturing apparatus according to the present embodiment. The vat 201 is inserted to a predetermined position of the vat guides 205 to be placed in the vat guides 205.

FIG. 4C is a perspective view illustrating the procedure of positioning of the platform by the three-dimensional additive manufacturing apparatus according to the present embodiment. As indicated by an arrow in FIG. 4C, a coarse adjustment block 207 (wedge-shaped block) is inserted between the manufacturing base 206 and the vat 201.

FIG. 4D is a perspective view illustrating the procedure of positioning of the platform by the three-dimensional additive manufacturing apparatus according to the present embodiment. After the coarse adjustment block 207 is inserted, the platform 202 is lowered.

FIG. 4E is a perspective view illustrating the procedure of positioning of the platform by the three-dimensional additive manufacturing apparatus according to the present embodiment. The lowering of the platform 202 is continued to lower the platform 202 down to the position where the manufacturing surface 221 of the platform 202 contacts the bottom surface 211 of the vat 201.

FIG. 4F shows a perspective view and a cross-sectional schematic view illustrating the procedure of positioning of the platform by the three-dimensional additive manufacturing apparatus according to the present embodiment. The diagram represented at the upper right in FIG. 4F is a cross-sectional schematic view taken along line A-A′ illustrating the positional relationship between the vat 201 and the coarse adjustment block 207. To avoid complex illustration, members not necessary for the description are omitted as appropriate. When the platform 202 is further lowered while the manufacturing surface 221 of the platform 202 contacts the bottom surface 211 of the vat 201, the vat 201 is also lowered together with the platform 202. The vat 201 is biased upwardly by the biasing members 203 while supported, and when the platform 202 is further lowered, the vat 201 is further lowered as well against the biasing forces of the biasing members 203. The platform 202 and the vat 201 stop the lowering in a position where the vat 201 abuts on the coarse adjustment block 207 (arrow in the cross-sectional schematic view in FIG. 4F).

FIG. 4G is a perspective view illustrating the procedure of positioning of the platform by the three-dimensional additive manufacturing apparatus according to the present embodiment. The coarse adjustment block 207 is then removed where the vat 201 is lowered and four fine adjustment blocks 207 are prepared. The four prepared fine adjustment blocks 207 are inserted to fill a gap between the manufacturing base 206 and the vat 201.

FIG. 4H shows a perspective view and a cross-sectional schematic view illustrating the procedure of positioning of the platform by the three-dimensional additive manufacturing apparatus according to the present embodiment. The diagram represented at the upper right in FIG. 4H is a cross-sectional schematic view taken along line B-B′ illustrating the positional relationship between the vat 201 and the fine adjustment blocks 207. To avoid complex illustration, members not necessary for the description are omitted as appropriate. The adjustment members 204 in the four positions are turned to press down the vat 201. The adjustment members 204 are turned until the vat 201 cannot be lowered any more (the adjustment members 204 cannot be turned) by being sandwiched between the fine adjustment blocks 207 and the adjustment members 204.

FIG. 4I is a perspective view illustrating the procedure of positioning of the platform by the three-dimensional additive manufacturing apparatus according to the present embodiment. When the vat 201 cannot be lowered any more, the four fine adjustment blocks 207 are removed. The number of the blocks 207 used for the fine adjustment may be three. When the fine adjustment blocks 207 are removed, the positioning of the platform 202 is completed. The position of the platform 202 thus determined is the so-called zero point (reference point). After the positioning of the platform 202 is completed, the platform 202 is raised (even after the platform 202 is raised, the position of the vat 201 remains to be maintained at the zero point (reference point)) to detach the vat 201. Into the detached vat 201, the manufacturing material is poured to set the vat 201 in the vat guides 205. After the setting of the vat 201 with the poured manufacturing material is completed, the platform 202 is lowered again down to the position of the zero point. At this point, preparation of the manufacture of a three-dimensional additively manufactured object is completed. After this point, a three-dimensional additively manufactured object is manufactured while lifting the platform 202 with a pitch of, for example, 2.5 μm.

FIG. 5 is a diagram illustrating the block used for the three-dimensional additive manufacturing apparatus according to the present embodiment. FIG. 5 illustrates a side view (510), a front view (520), and a partial enlarged view (530) of the block 207. The block 207 in a vertical orientation is illustrated in the side view (510). The vertically orientated block 207 is applicable as the fine adjustment block 207. The vertically orientated block 207 has an adjustment surface 501, which is a slope formed stepwise as illustrated in the partial enlarged view (530). That is, the vertically orientated block 207 has the adjustment surface 501 formed in a wedge shape for fine adjustment. As described earlier, the fine adjustment is performed by, while the platform 202 is moved downward and the manufacturing surface 221 presses down the bottom surface 211, inserting the wedge-shaped portion of the block 207 between the vat 201 and the manufacturing base 206 and turning the adjustment members 204 until the vat 201 cannot be lowered any more (until the adjustment members 204 cannot be turned).

With reference to the partial enlarged view (530), the adjustment surface 501 is formed stepwise, and for example, each step has a width (length in the depth direction of each step) of 0.55 mm and a pitch (interval) of 0.2 mm and the number of steps is 11. The block 207 has a height (height from the manufacturing base surface) from 7 mm to 9 mm with a design center of 8 mm and an adjustable range of 2 mm. The width, the pitch, the number of steps, and the height mentioned here are merely examples, and for example, each step may have different width and pitch and they may be appropriately modified in accordance with the purpose of the adjustment by the block 207.

In addition, the block 207 is in a horizontal orientation by tilting 90 degrees to the right from the vertical orientation illustrated in the side view (510). The horizontally orientated block 207 is applicable as the coarse adjustment block 207. The coarse adjustment is performed using an adjustment surface 502. As described earlier, the coarse adjustment is performed by inserting the horizontally orientated block 207 between the vat 201 and the manufacturing base 206 in advance, moving the platform 202 downward, and causing the manufacturing surface 221 to press down the bottom surface 211 to define the position where the vat 201 abuts on the block 207 and cannot be lowered any more.

While the example illustrated in FIG. 5 is the block 207 obtained by integrally forming, as a single piece, the coarse adjustment block 207 and the fine adjustment block 207, the coarse adjustment block 207 and the fine adjustment block 207 may be separate blocks.

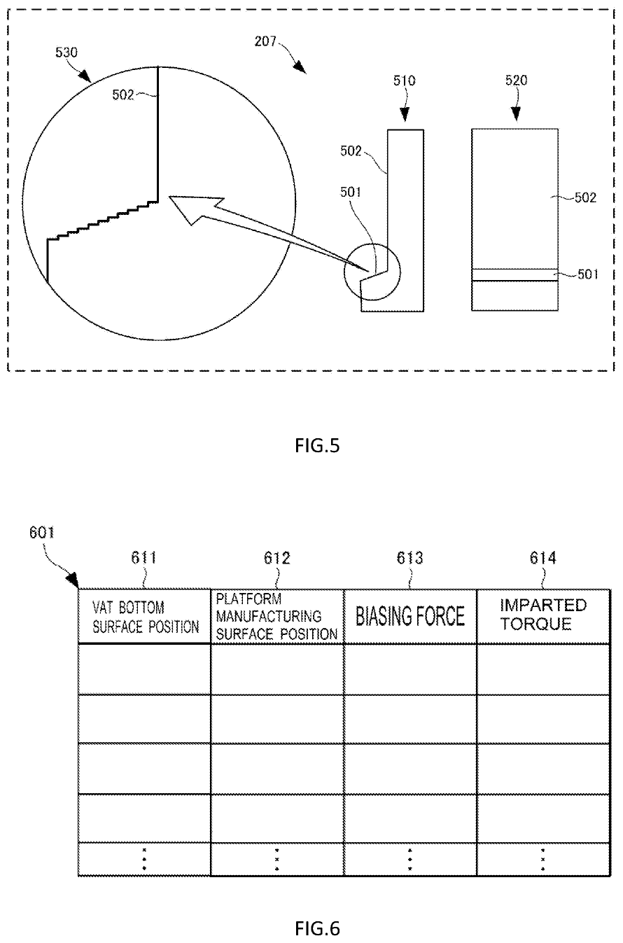

FIG. 6 is a chart illustrating an example of an adjustment table of an information processing section, not shown, included in the three-dimensional additive manufacturing apparatus according to the present embodiment. An adjustment table 601 stores, in association with a vat bottom surface position 611, a platform manufacturing surface position 612, a biasing force 613, and an imparted torque 614. The vat bottom surface position 611 represents a position of the bottom surface 211 of the vat 201. The platform manufacturing surface position 612 represents a position of the manufacturing surface 221 of the platform 202. The biasing force 613 represents biasing forces by the biasing members 203. The imparted torque 614 represents torques imparted to the adjustment members 204.

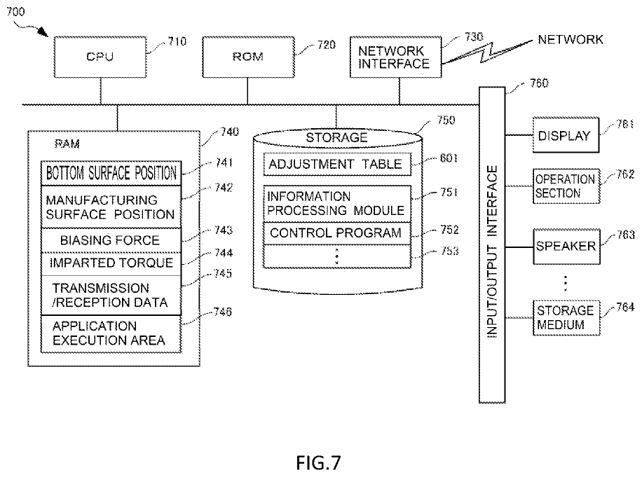

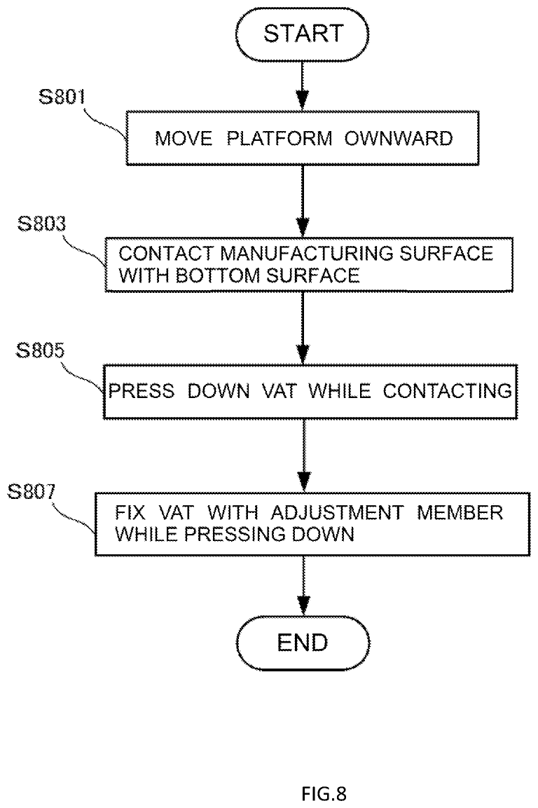

FIG. 7 is a block diagram illustrating hardware configuration of the information processing section 700 included in the three-dimensional additive manufacturing apparatus according to the present embodiment. A central processing unit (CPU) 710 is a processor for arithmetic control achieves a functional component of the information processing section 700 in the three-dimensional additive manufacturing apparatus by executing a program. The CPU 710 may have a plurality of processors to concurrently execute different programs, modules, tasks, threads, and the like. A read only memory (ROM) 720 stores fixed data, such as initial data and programs, and other programs. A network interface 730 communicates with another apparatus and the like via a network. The CPU 710 is not limited to one and may be a plurality of CPUs or may include a graphics processing unit (GPU) for image processing. The network interface 730 desirably has a CPU independent from the CPU 710 to write or read transmission/reception data in an area of a random access memory (RAM) 740. It is desired to provide a direct memory access controller (DMAC), not shown, to transfer data between the RAM 740 and a storage 750. Moreover, the CPU 710 recognizes reception or transfer of data by the RAM 740 and processes the data. The CPU 710 prepares a processed result in the RAM 740 and leaves the following transmission or transfer to the network interface 730 or the DMAC.

The RAM 740 is a random access memory used as a work area for temporary storage by the CPU 710. The RAM 740 secures an area to store data for achievement of the present embodiment. A bottom surface position 741 represents a position of the bottom surface 211 of the vat 201. A manufacturing surface position 742 represents a position of the manufacturing surface 221 of the platform 202. A biasing force 743 represents biasing forces by the biasing members 203. An imparted torque 744 represents torques imparted to the adjustment members 204.

Transmission/reception data 745 represents data transmitted or received via the network interface 730. The RAM 740 also has an application execution area 746 to execute various application modules.

The storage 750 stores a database, various parameters, and data and programs below for achievement of the present embodiment. The storage 750 stores the adjustment table 601. The adjustment table 601 is the table illustrated in FIG. 6 to manage the vat bottom surface position 611 in association with the imparted torque 614 and the like.

The storage 750 further stores an information processing module 751. The information processing module 751 is a module to fix the position of the vat 201 using the adjustment members 204 in a state where the platform 202 is moved downward to contact the manufacturing surface 221 with the bottom surface 211 and the vat 201 is pressed down against the biasing forces of the biasing members 203 to press down the vat 201. The information processing module 751 is read and executed by the CPU 710 in the application execution area 746 of the RAM 740. A control program 752 is a program to control the entire three-dimensional additive manufacturing apparatus 200.

FIG. 8 is a flowchart illustrating a processing procedure by the information processing section included in the three-dimensional additive manufacturing apparatus according to the present embodiment. This flowchart is executed by the CPU 710 in FIG. 7 using the RAM 740 to achieve the functional component of the information processing section 700 in the three-dimensional additive manufacturing apparatus 200. At step S801, the three-dimensional additive manufacturing apparatus 200 moves the platform 202 downward. At step S803, the three-dimensional additive manufacturing apparatus 200 causes the manufacturing surface 221 to contact with the bottom surface 211. At step S805, while the manufacturing surface 221 contacts with the bottom surface 211, the three-dimensional additive manufacturing apparatus 200 presses down the vat 201 against the biasing forces of the biasing members 203. At step S807, while the vat 201 is pressed down, the three-dimensional additive manufacturing apparatus 200 fixes the position of the vat 201 using the adjustment members 204.

The present embodiment allows accurate positioning of the vat and the platform. The present embodiment also allows reliable parallelization of the bottom surface of the vat with the manufacturing surface of the platform.

### Third Embodiment

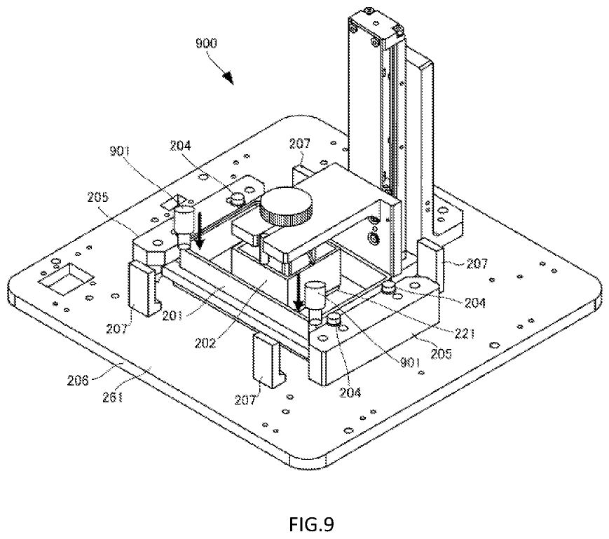

With reference to FIG. 9, a three-dimensional additive manufacturing apparatus according to the third embodiment of the present invention is then described. FIG. 9 is a perspective view illustrating the three-dimensional additive manufacturing apparatus according to the present embodiment. The three-dimensional additive manufacturing apparatus according to the present embodiment is different from the second embodiment in having pressing members. Since other configuration and operation are same as those in the second embodiment, same reference signs are given to the same configuration and operation to omit the description in detail.

A three-dimensional additive manufacturing apparatus 900 has pressing members 901. The pressing members 901 press the vat 201 downward against the upward biasing forces of the biasing members 203 for each formation of one layer of a three-dimensional additively manufactured object. In other words, when a photocurable resin as a manufacturing material contained in the vat 201 is irradiated with the light beam 231 and manufacture for the one layer of the three-dimensional additively manufactured object is completed, the cured manufacturing material and the bottom surface 211 of the vat 201 are in close contact with each other, causing a strong release force to be occurred when a next layer is manufactured. This means that a load is applied to the strength of the structure of a stepping motor and the like that controls vertical movement of the platform 202. Moreover, one layer of the three-dimensional additively manufactured object has a small thickness approximately from several μm to tens of μm, causing difficulty in precise control of small movement under the strong release force. The present embodiment causes the pressing members 901 to press the vat 201 downward for each manufacture of one layer to allow release of the close contact between the cured manufacturing material and the bottom surface 211 of the vat 201. The load applied to the strength of the structure accordingly decreases and it is thus possible to precisely control the movement of the platform 202.

The present embodiment causes the pressing members to press the vat downward to readily control the movement of the platform.

### Fourth Embodiment

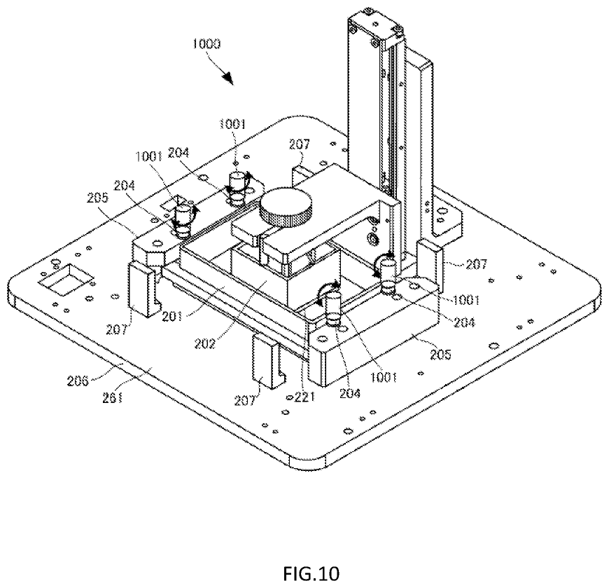

With reference to FIG. 10, a three-dimensional additive manufacturing apparatus according to the fourth embodiment of the present invention is then described. FIG. 10 is a perspective view illustrating the three-dimensional additive manufacturing apparatus according to the present embodiment. The three-dimensional additive manufacturing apparatus according to the present embodiment is different from the second and third embodiments in having control sections. Since other configuration and operation are same as those in the second and third embodiments, same reference signs are given to the same configuration and operation to omit the description in detail.

A three-dimensional additive manufacturing apparatus 1000 has control sections 1001. The control sections 1001 control adjustment levels by the adjustment members 204 while detecting axial forces exerted on the adjustment members 204 to adjust the vertical position of the vat 201.

The control sections 1001 are, for example, members capable of achieving a rotary motion by a motor or the like and have a shape fitting the shape of the heads of the adjustment members 204 or have a structure capable of holding the heads. The control sections 1001 imparts a rotational torque to the adjustment members 204, and the adjustment members 204 are fastened with the imparted rotational torque. The control sections 1001 configured to thus control the rotational torque imparted to the adjustment members 204 allows a uniform rotational torque to be imparted to the adjustment members 204.

In addition, the three-dimensional additive manufacturing apparatus 1000 may be provided with at least three of the adjustment members 204 and the control sections 1001 may be configured to simultaneously control adjustment levels by the at least three adjustment members 204. That is, the control sections 1001 simultaneously control amounts of fastening the at least three adjustment members 204 to adjust the vertical position of the vat 201.

The detection of the axial forces exerted on the adjustment members 204 by the control sections 1001 may be performed by, but not limited to, using a force sensor, an encoder, and the like, for example, or counting the number of revolutions of the control sections 1001.

The present embodiment causes the control sections to control the adjustment levels of the adjustment members, thereby allowing precise control of the adjustment members. The present embodiment also allows simultaneous control of at least three adjustment members and thus allows uniform control of the adjustment levels.

### OTHER EMBODIMENTS

While the present invention has been described with reference to the above embodiments, the present invention is not limited to these embodiments. Various modifications understood by those skilled in the art may be made to the present invention in the configuration and details within the scope of the present invention. In addition, the scope of the present invention also includes all systems and devices that are made by any combination of separate characteristics included in the respective embodiments.

Still in addition, the present invention may be applied to a system configured from a plurality of devices or may be applied to a single device. Moreover, the present invention is also applicable to the case of supplying an information processing program to achieve the functions in embodiments directly or remotely to the system or the device. Accordingly, the scope of the present invention also includes a program installed in a computer to achieve the functions of the present invention by the computer, a medium having the program stored therein, and a world wide web (WWW) server to download the program. In particular, the scope of the present invention includes at least a non-transitory computer readable medium having a program causing a computer to execute the processing steps included in the above embodiments.

1. A three-dimensional additive manufacturing apparatus, comprising:
a vat being a member to contain a manufacturing material and having a bottom surface to transmit a light beam from a light source provided below;
a platform having a downward manufacturing surface facing the bottom surface and configured to lift a manufactured object for each manufacture of one layer, the manufactured object being additively manufactured per layer on the manufacturing surface;
a biasing member biasing upward the vat while supporting; and
an adjustment member configured to adjust a vertical position of the vat at least at three points, wherein
in a state where the platform is moved downward to contact the manufacturing surface with the bottom surface and press down the vat against a biasing force of the biasing member, the position of the vat is adjusted using the adjustment member.

2. The three-dimensional additive manufacturing apparatus according to claim 1, wherein the adjustment member presses the vat downward against the biasing force of the biasing member.

3. The three-dimensional additive manufacturing apparatus according to claim 1, further comprising a vat guide including the biasing member and the adjustment member and configured to guide an end edge portion of the vat between the biasing member and the adjustment member.

4. The three-dimensional additive manufacturing apparatus according to claim 3, further comprising a manufacturing base to mount the vat guide, wherein
the vat guide is attached to a reference plane as an upper surface of the manufacturing base to define a position of the adjustment member from the reference plane.

5. The three-dimensional additive manufacturing apparatus according to claim 4, further comprising a coarse adjustment block configured to be inserted between the vat and the manufacturing base in advance to define a lowest position of the vat when the platform is moved downward and the manufacturing surface presses down the bottom surface.

6. The three-dimensional additive manufacturing apparatus according to claim 4, further comprising a fine adjustment wedge-shaped block configured to be inserted between the vat and the manufacturing base to define an adjustment position of the adjustment member in a state where the platform is moved downward and the manufacturing surface presses down the bottom surface.

7. The three-dimensional additive manufacturing apparatus according to claim 4, further comprising an adjustment block obtained by integrally forming, as a single piece:
a coarse adjustment block configured to be inserted between the vat and the manufacturing base to define a lowest position of the vat when the platform is moved downward and the manufacturing surface presses down the bottom surface; and
a fine adjustment wedge-shaped block configured to be inserted between the vat and the manufacturing base to define an adjustment position of the adjustment member in a state where the platform is moved downward and the manufacturing surface presses down the bottom surface.

8. The three-dimensional additive manufacturing apparatus according to claim 6, wherein the wedge-shaped block includes an adjustment surface formed stepwise.

9. The three-dimensional additive manufacturing apparatus according to claim 1, further comprising a pressing member configured to press the vat downward against the upward biasing force of the biasing member for each formation of one layer of the manufactured object.

10. The three-dimensional additive manufacturing apparatus according to claim 1, further comprising a control section configured to adjust the vertical position of the vat by controlling an adjustment level by the adjustment member while detecting an axial force exerted on the adjustment member.

11. The three-dimensional additive manufacturing apparatus according to claim 10, wherein
at least three of the adjustment members are provided, and
the control section simultaneously controls adjustment levels by the at least three adjustment members.

12. A method of adjusting a three-dimensional additive manufacturing apparatus including
a vat being a member to contain a manufacturing material and having a bottom surface to transmit a light beam from a light source provided below,
a platform having a downward manufacturing surface facing the bottom surface and configured to lift a manufactured object for one layer, the manufactured object being additively manufactured per layer on the manufacturing surface,
an upward biasing member biasing upward the vat while supporting, and
an adjustment member configured to adjust a vertical position of the vat at least at three points, the method comprising the steps of:
moving the platform downward;
contacting the manufacturing surface with the bottom surface and pressing down the vat against a biasing force of the biasing member; and
fixing a position of the vat using the adjustment member in a state where the vat is pressed down.

13. A program for adjusting a three-dimensional additive manufacturing apparatus including
a vat being a member to contain a manufacturing material and having a bottom surface to transmit a light beam from a light source provided below,
a platform having a downward manufacturing surface facing the bottom surface and configured to lift a manufactured object for one layer, the manufactured object being additively manufactured per layer on the manufacturing surface,
an upward biasing member biasing upward the vat while supporting, and
an adjustment member configured to adjust a vertical position of the vat at least at three points, the program causing a computer to execute the steps of:
moving the platform downward;
contacting the manufacturing surface with the bottom surface and pressing down the vat against a biasing force of the biasing member; and
fixing a position of the vat using the adjustment member in a state where the vat is pressed down.

14. The three-dimensional additive manufacturing apparatus according to claim 2, further comprising a vat guide including the biasing member and the adjustment member and configured to guide an end edge portion of the vat between the biasing member and the adjustment member.

15. The three-dimensional additive manufacturing apparatus according to claim 5, further comprising a fine adjustment wedge-shaped block configured to be inserted between the vat and the manufacturing base to define an adjustment position of the adjustment member in a state where the platform is moved downward and the manufacturing surface presses down the bottom surface.

16. The three-dimensional additive manufacturing apparatus according to claim 7, wherein the wedge-shaped block includes an adjustment surface formed stepwise.
